(19) United States
(12) Patent Application Publication
(10) Pub. No.: US 2015/0084788 A1
(43) Pub. Date: Mar. 26, 2015

(54) Earthquake Warning Disaster Prevention and Safety Report-Back System

(71) Applicant: Bingotimes Digital Technology Co., Ltd., Taichung City (TW)

(72) Inventor: MING-CHE WU, Taichung City (TW)

(73) Assignee: Bingotimes Digital Technology Co., Ltd., Taichung City (TW)

(21) Appl. No.: 14/265,323

(22) Filed: Apr. 29, 2014

(30) Foreign Application Priority Data
Sep. 24, 2013 (TW) 102134466

(51) Int. Cl. G01V 1/00; G08B 27/00; G08B 21/10

(52) U.S. Cl. CPC G01V 1/008; G08B 21/10; G08B 27/006
USPC 340/870.16

(57) ABSTRACT

An earthquake warning disaster prevention and safety report-back system comprises a servo host group constituted by servo hosts and a mobile communication device. When an earthquake is formed, the servo hosts that are distributed by location in Taiwan are utilized for simultaneously receiving earthquake real-time data information transmitted from the Central Weather Bureau, using the servo hosts to evaluate a physical location of a client, and using one servo host that is located at an optimum (nearest) site to distributively transmit earthquake real-time data information to the mobile communication device of the client. When the mobile communication device receives the earthquake information, the mobile communication device transmits a warning message to the client and provides earthquake magnitude and an earthquake wave arrival time of the physical location as instructions to perform prevention and escape measures, thereby seizing the recuse golden hour. Besides, the invention can provide a safety report-back system for the family members, thus to understand the damage condition and real-time coordinates of the family member and to obtain an emergency help and a rescue searching after disaster. With the above-described frame of the system, the family members can receive the real-time earthquake prediction notification to seize the escape time and to reduce casualties and deaths, and the family member can mutually transmit safety-back report states to conveniently and practically ensure the searching and rescuing direction.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an earthquake warning disaster prevention and safety report-back system, and in particular relates to a system utilizing a mobile communication device capable of providing earthquake information of a client location and reporting self-safety state back to family members.

2. Description of Related Arts

Earthquake is one of the main natural disasters commonly seen in Taiwan area where is located in circum-Pacific earthquake belt. When an earthquake occurs, grounds are violently vibrated and houses and buildings are destroyed, resulting in serious losses of human life and properties. Earthquake waves are generally classified into P and S waves, in which the P wave is featured of faster propagation velocity and lesser destructive power, and the S wave is featured of lesser propagation velocity and more destructive power. Although the earthquake cannot be effectively predicted in advance, the P wave of the earthquake which is first arrived in a location prior to the S wave thereof can be predicted in accordance to the propagation property of the earthquake wave, and the earthquake intensity and the arrival time of the coming S wave of the earthquake can be estimated with reference to history earthquake data. With an automatic real-time tele-seismic system activated by the Central Weather Bureau (CWB), when occurring a near sensible earthquake or a large distant earthquake, earthquake data can be immediately transmitted back to each station via a leased line so as to immediately calculate epicenter location, earthquake source depth and earthquake magnitude and to publish a seismic report, and therefore various of propagation methods (e.g., broadcasts, television stations, the Internet, etc.) can be utilized for informing the public of the earthquake news as early as possible to seize the golden hour for escape.

In the case of Japan Earthquake 311, people who live in Tokyo, where is of 300 to 400 kilometers apart from the earthquake location, can feel a maximum vibration about two minutes later after the earthquake occurs. That is, if there are 20 to 30 seconds to be required for the real-time prediction operation in Tokyo area, the resident there can have 1.5 minutes of prediction time to sufficiently deal with any contingency and emergency, thus to reduce any possible disasters resulting from the earthquake. Although Taiwan has earthquake environment conditions much different from that of Japan, especially of a very short prediction time, provision of ten or more seconds, or even dozens of seconds of prediction time are crucial to the resident for reducing disasters resulting from the earthquake.

Taiwan Publication Patent No. 200714006 discloses an escape evacuation decision support system. In '006 case, satellite positioning, mobile communication network transmission and evacuation system are integrated for building a real-time escape route planning for escape evacuation devices with regard to nature disasters (e.g. mudslide, earthquake or typhoon), transmitting the positioning information to the decision source system and utilizing the positioning information and the related geometrical information to acquire an optimal escape route, thereby attaining the main purpose of assisting end users of hand-held apparatuses in escaping from the disaster area.

Further, Taiwan Patent Gazette No. 1347566 discloses a warning system, a portable communication device and a warning method. In '566 case, the portable communication device can access an architectural structure drawing of a building as being entered therein and display the current position information in cooperation with the positioning function. People can acquire an evacuation message from the portable communication device carried therewith when a dangerous condition is occurred, thereby assisting the people in escaping from the building.

However, these above-described conventional skills exist problems as follows.

Firstly, because the conventional system and method only utilize one server to manage the operation, throughput of the server will be instantaneously increased if disasters are occurred, resulting in network congestion and the client unable to connect the server. Probably, if the server located in a disaster area is damaged when disasters are occurred, the conventional system is disabled and cannot be normally operated, unable to functionally inform and alarm the client and plan the escape route.

Secondly, although the satellite positioning and the mobile communication network transmission are utilized to transmit the disaster message, the above-described conventional system and method still cannot advantageously and optimally seize the golden hour for escape and evacuation based on the precursory earthquake information.

Thirdly, the above-described conventional system and method can be just applied to plan the escape route, unable to integrate full-scale disaster treatments and evacuation measures on helps and rescues after evacuation. Above all, the above-described conventional system and method does not provide safety report-back communication of between friends and relatives after the disasters are occurred, unable to acquire that whether the relative is survived or not and rescue searching direction.

### SUMMARY OF THE PRESENT INVENTION

The main purpose of the invention is to provide an earthquake warning disaster prevention and safety report-back system, to practically, effectively and conveniently solve the above problems in conventional skills.

In one purpose of the invention, a plurality of servo hosts of a servo host group 20 that are distributed by location are utilized to evaluate a physical location of a client, and the servo host 21 that is located at an optimum site is utilized to distributively transmit earthquake real-time data information 10 to a client's mobile communication device 30, thereby preventing over-centralized clients and data transmittal delay, prediction time reduction. Further, with the servo host group 20 constituted by the plurality of servo hosts 21, the invention can still be normally operated even if one of the servo hosts 21 is damaged, viz. using other servo hosts 21 to replace the malfunctioned one, thereby attaining the effect of multiple insurance.

In another purpose of the invention, after the earthquake real-time data information 10 is received by the mobile communication device 30, the mobile communication device 30 can provide functions of warning and notifying the client and display earthquake magnitude of the physical location and a final countdown time information of an arrived earthquake wave, thereby enabling the client to safely escape and seizing the golden hour for recuse.

In still another purpose of the invention, when the member is arrived in a safety escape location, a family member notification unit can be utilized for reporting self-safety state of the member back to each family member, acquiring safety state and coordinate locations of other family members, performing a rescue searching measure to the family member who is the disconnected or transmits the help message according to final coordinate location, and seizing the golden hour for recuse.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a frame view of a system of the invention;

FIG. 2 is a frame schematic view of a servo host group of the invention; and

FIG. 3 is a frame schematic view of a client side of a mobile communication device of the invention.

### DETAILED DESCRIPTION OF THE PREFERRED EMBODIMENT

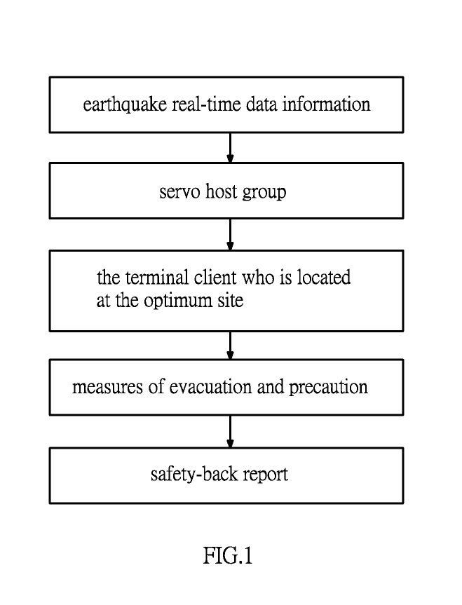

Referring to FIGS. 1, 2 and 3, an earthquake warning disaster prevention and safety report-back system of the invention comprises a servo host group 20 and a mobile communication device 30. The servo host group 20 is constituted by networking a plurality of servo hosts 21 that are distributed by location in Taiwan and utilized for simultaneously receiving earthquake real-time data information 10 transmitted from the Central Weather Bureau (CWB). The servo host 21 comprises a client location evaluation unit 210 that is utilized for evaluating a physical location of a client to distribute and transmit a client information optimum site and an earthquake data transmission unit 211 that is utilized for receiving a distribution instruction analyzed by the client location evaluation unit 210 to transmit servo host earthquake information 50 to the mobile communication device 30 of the client. The mobile communication device 30 utilized for receiving the servo host earthquake information 50 comprises a calculation control unit 31, a positioning unit 32, a family member database 33, an earthquake warning unit 35, a family member notification unit 36, an emergency help unit 37 and a rescue searching unit 38. The calculation control unit 31 that is coupled to the positioning unit 32, the family member database 33, the earthquake warning unit 35, the family member notification unit 36, the emergency help unit 37 and the rescue searching unit 38 is utilized for receiving the servo host earthquake information 50 and solving an earthquake wave arrival time and earthquake magnitude of the physical location by cooperating current location information of the positioning unit 32. The positioning unit 32 is capable of transmitting the information of the physical location to the servo host group 20 and the calculation control unit 31 and calculating coordinates and distances by cooperating network map information.

The family member database 33 is the client's personal family member data that is served as a basis for the family member to notify unit member data, capable of adding or deleting the family member for updating vial an update input unit 34.

The earthquake warning unit 35 is utilized for warning or notifying the client of the location earthquake information solved by the calculation control unit 31 and providing a refuge information and a distance thereto.

The family member notification unit 36 to be based on the family member database 33 is utilized for reporting self-safety state back to each family member, acquiring safety state of other family members, and transmitting the data of disconnected and wounded family members to the rescue searching unit 38.

The emergency help unit 37 is capable of automatically sensing or independently transmitting notification when a dangerous condition is occurred and transmitting a help message to notify the rescue searching unit 38 that includes the family member of the family member database 33.

The rescue searching unit 38 is utilized for receiving safety report-back information and help notification transmitted from all family member of the family member database 33 and capable of performing a rescue searching measure to the family member who is the disconnected or transmits the help message according to final coordinate location.

The configuration of the invention is described in detail hereinafter. As shown in FIG. 1, a frame view of a system of the invention is schematically illustrated. By using conventional techniques to access data from the earthquake real-time data information 10 transmitted from the CWB and establishing the servo hosts 21 at least in the northern, middle, southern and eastern parts of Taiwan respectively to network into the servo host group 20 for simultaneously receiving data transmitted from the earthquake real-time data information 10 to calculate the distance to the physical location of the client, the invention can transmit messages to the terminal client who is located at the optimum site and provides earthquake real-time information to the clients, thereby enabling the client to immediately take measures of evacuation and precaution to reduce casualties and deaths and transmitting a safety-back report state to the family member as a basis for emergency rescue after disaster.

In the invention, examples of usage objects and escape prevention measures are described as follows.

For common clients:

(1) National freeway users: slowdown, avoidance, and parking to safety regions;

(2) Housewives: shutdowns to fuel gas, natural gas and power source; and

(3) Staffs of climbing and aloft work: emergency avoidances and escapes.

For public places:

(1) Office buildings: elevator controls, broadcasts, evacuations, and startups of backup systems;

(2) Schools: broadcasts and student guide evacuations;

(3) Parking towers: lifting device controls; and

(4) Stations: broadcasts (multiple languages), evacuations, marquee plugs, and video frequency plugs.

For special mechanisms:

(1) Hospitals: operation room evaluation, startups of backup systems and data retention;

(2) Laboratories: startups of backup systems, data retention and precision device shutdown; and

(3) Oil gas device shops: startups of disaster prevention processes and warning lamp, and broadcasts.

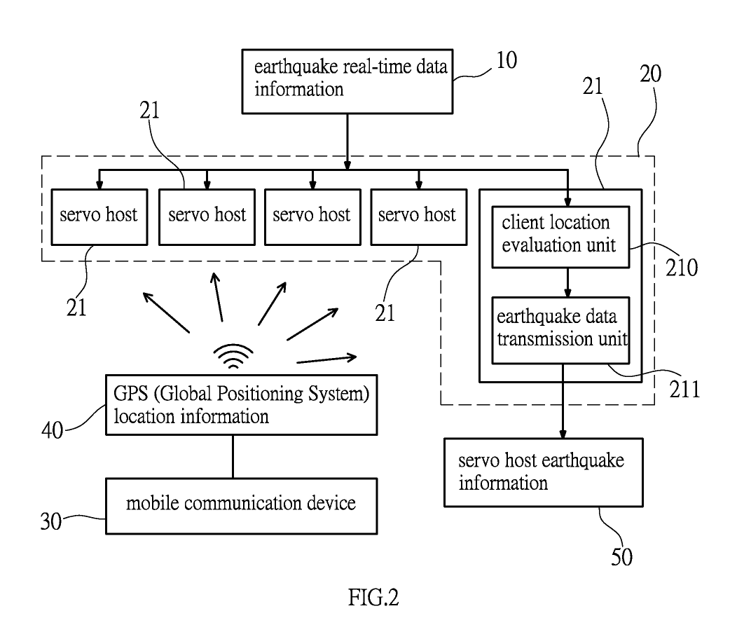

Referring to FIG. 2, a frame schematic view of a servo host group 20 of the invention is illustrated. The servo host group 20 which is constituted by networking the servo hosts 21 established at least in the northern, middle, southern and eastern parts of Taiwan respectively is utilized for simultaneously receiving data transmitted from the earthquake real-time data information 10. When an earthquake is formed, the computer of the CWB immediately calculates the earthquake data transmitted from each seismometers distributed by location and transmits the earthquake real-time data information 10, and the servo host group 20 can immediately receive the earthquake information from a permanent network connection. Besides, after GPS (Global Positioning System) location information 40 of all clients that are collected by the servo hosts 21 on the basis of the nearest one is calculated and analyzed by the client location evaluation unit 210 of the servo host 21, the earthquake data transmission unit 211 is commanded to transmit the servo host earthquake information 50 to the mobile communication devices 30 of the nearby clients. If the earthquake is continuously occurred, the earthquake data transmission unit 211 is commanded to transmit the servo host earthquake information 50 to the mobile communication devices 30 of the clients in accordance with the time sequence of earthquakes, viz. distributing the data to the clients by a distributed data transmittal method, thereby avoiding network congestion of a single servo hosts 21 to delay the data transmittal and relatively reducing the prediction time of earthquake. Further, if a servo host 21, which is located in and closest one to a disaster area, is unable to transmit data malfunctionedly, the mobile communication device 30 of the clients is automatically switched and communicated with a second closest servo host 21 for data transmittal. That is, with the servo host group 20 constituted by the plurality of servo hosts 21 of the invention capable of providing multiple protections and guaranties, problems of unable to transmit the earthquake information by a single host that is located in the disaster area or malfunctioned can be sufficiently solved.

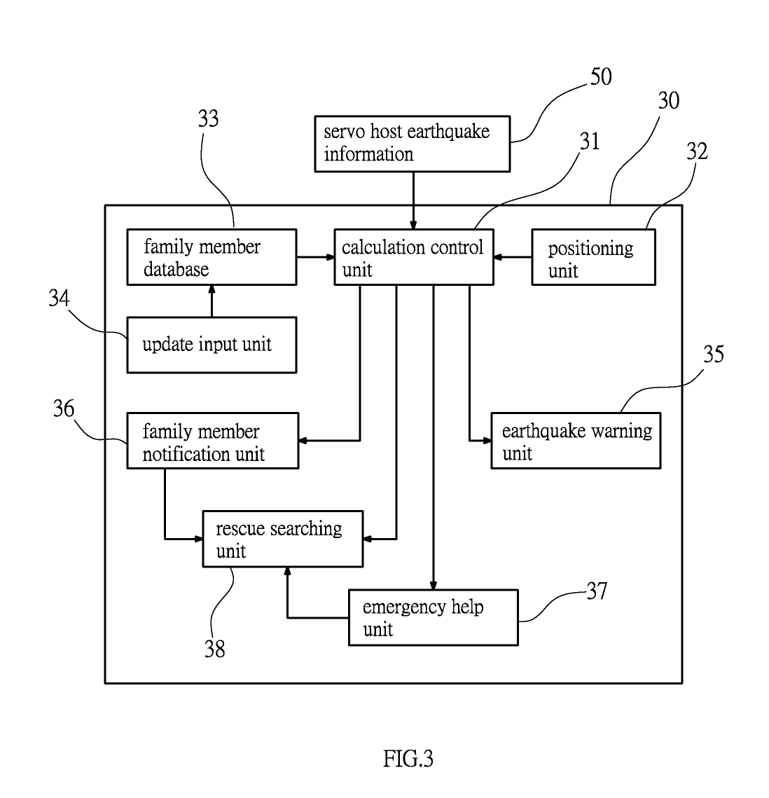

Referring to FIG. 3, a frame schematic view of a client side of the mobile communication device 30 of the invention is illustrated. After the servo host earthquake information 50 is received by the calculation control unit 31 of the mobile communication device 30, the calculation control unit 31 of the mobile communication device 30 can solve a final countdown second of an earthquake wave arrival time and earthquake magnitude of the physical location by cooperating the current location information of the positioning unit 32, calculate an epicenter and a location distance of the earthquake by cooperating the network map information, and transmit the calculated message to the earthquake warning unit 35. The earthquake warning unit 35 can be utilized to list the received earthquake information, which includes date, time, magnitude, longitude and latitude, depth, and distance epicenter related to the occurred earthquake sources, and the earthquake magnitude and the earthquake wave arrival time (the final countdown second) related to the client location, to allow the mobile communication device 30 to inform the client of the earthquake information in the form of lights, voices and vibrations, and to provide refuge information and the distance of the current location. Further, the family member database 33 of the invention is connectedly arranged with an update input unit 34 capable of inputting telephone numbers to add family member data to family member database 33 or selecting a list of the family member for deletion. Therefore, the family member notification unit 36 can utilize the list of the family member database 33 to manage, notify and issue the messages (e.g., information including family message boards, self-safety report-back states, family member safety report-back states, and family gathering sites) related to the family members, and can provide other family members with a function of inquiring the final coordinate location and distance of each family member. It is noted that the emergency help unit 37 of the invention can be classified into two modes comprising a general period mode and a special period mode. In a help starting time of the general period mode, a sensor built in the mobile communication device 30 is utilized for sensing a non-normal vibration (e.g., an instantaneous pulling force representing a tumbling down condition, etc.) or a record program built in the mobile communication device 30 is utilized for recording a personal voice-controlled mayday word and a personal high volume mayday voice, allowing to notify the mobile communication device 30 to automatically call a help signal or produce a high decibel alarm whistle voice; at a help starting time of the special period mode that is formed when a location is in a strong earthquake status, the mobile communication device 30 immediately and enforcedly shuts down other operating programs and turns into a power-saving status, the help message (including GPS coordinates) is automatically transmitted to the family member notification unit 36 and the rescue searching unit 38. When the earthquake is stopped and a client survival message is acquired by using the sensor built in the mobile communication device 30 to sense a vibration message (e.g, for sensing displacement quantity), the help message is immediately released and the client in a safety state is reported back to the family member notification unit 36 and to other family members. The rescue searching unit 38 informed by the family member notification unit 36 and the emergency help unit 37 is capable of performing a rescue searching measure to the family member who is the disconnected or transmits the help message according to the message of the mobile communication device 30 and the final coordinate location, thereby enabling the client to safely escape and seizing the golden hour for recuse.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An earthquake warning disaster prevention and safety report-back system comprising a servo host group and a mobile communication device, in which:
the servo host group is constituted by networking a plurality of servo hosts distributed by location and utilized for simultaneously receiving earthquake real-time data information, and the servo host comprises a client location evaluation unit that is utilized for evaluating a physical location of a client to distribute and transmit a client information optimum site and an earthquake data transmission unit that is utilized for receiving a distribution instruction analyzed by the client location evaluation unit to transmit servo host earthquake information to the mobile communication device of the client; and
the mobile communication device utilized for receiving the servo host earthquake information comprises a calculation control unit, a positioning unit, a family member database, an earthquake warning unit, a family member notification unit, an emergency help unit and a rescue searching unit, in which the calculation control unit that is coupled to the positioning unit, the family member database, the earthquake warning unit, the family member notification unit, the emergency help unit and the rescue searching unit is utilized for receiving the servo host earthquake information and solving an earthquake wave arrival time and earthquake magnitude of the physical location by cooperating current location information of the positioning unit; the positioning unit is capable of transmitting the information of the physical location to the servo host group and the calculation control unit and calculating coordinates and distances by cooperating network map information; the family member database comprise the client's personal family member data that is served as a basis for the family member to notify unit member data;
the earthquake warning unit is utilized for warning or notifying the client of the location earthquake information solved by the calculation control unit and providing a refuge information and a distance thereto; the family member notification unit to be based on the family member database is utilized for reporting self-safety state back to each family member, acquiring safety state of other family members, and transmitting the data of disconnected and wounded family members to the rescue searching unit; the emergency help unit is capable of automatically sensing or independently transmitting notification when a dangerous condition is occurred and transmitting a help message to notify the rescue searching unit that includes the family member of the family member database;
and the rescue searching unit is utilized for receiving safety report-back information and help notification transmitted from all family member of the family member database and capable of performing a rescue searching measure to the family member who is the disconnected or transmits the help message according to final coordinate location.

2. The earthquake warning disaster prevention and safety report-back system as claimed in claim 1, wherein the earthquake information notified by the earthquake warning unit comprises earthquake magnitude and an earthquake wave final countdown second of the physical location.

3. The earthquake warning disaster prevention and safety report-back system as claimed in claim 2, wherein a client is notified by the earthquake warning unit in the form of lights, sounds and vibrations.

4. The earthquake warning disaster prevention and safety report-back system as claimed in claim 1, wherein the family member database is connectedly arranged with an update input unit capable of inputting telephone numbers to add family member data to family member database or selecting a list of the family member for deletion.

5. The earthquake warning disaster prevention and safety report-back system as claimed in claim 1, wherein the emergency help unit is classified into two modes comprising a general period mode and a special period mode, in which, in a help starting time of the general period mode, a sensor built in the mobile communication device is utilized for sensing a non-normal vibration or a record program built in the mobile communication device is utilized for recording a personal voice-controlled mayday word and a personal high volume mayday voice, allowing to notify the mobile communication device to automatically call a help signal or produce a high decibel alarm whistle voice;
at a help starting time of the special period mode that is formed when a location is in a strong earthquake status, the mobile communication device immediately and enforcedly shuts down other operating programs and turns into a power-saving status, the help message is automatically transmitted to the family member notification unit and the rescue searching unit; and when the earthquake is stopped and a client survival message is acquired by using the sensor built in the mobile communication device to sense a vibration message, the help message is immediately released and the client in a safety state is reported back to the family member notification unit.
